(19) United States
(12) Patent Application Publication
(10) Pub. No.: US 2004/0009302 A1
(43) Pub. Date: Jan. 15, 2004

(54) Non-slip garment and methods of fabricating same

(76) Inventor: Kathleen Patterson, New York, NY (US)

Correspondence Address: Irving M. Weiner, Weiner & Burt, P.C., 635 N. US-23, P.O. Box 186, Harrisville, MI, 48740, US

(21) Appl. No.: 10/431,308

(22) Filed: May 7, 2003

Related U.S. Application Data
(60) Provisional application No. 60/378,834, filed on May 7, 2002.

(51) Int. Cl. B05D 7/00; B05D 1/36

(52) U.S. Cl. 427/412

(57) ABSTRACT

Hosiery, socks, pantyhose, stockings and tights with one or more slip-resistant portions located at the outside bottom of the foot portion, at the heel and metatarsal areas. Also disclosed is a novel method of fabricating a non-slip garment.

The present patent application is based on and claims priority from U.S. Provisional Patent Application Serial No. 60/378,834 filed May 7, 2002.

The present invention relates generally to a non-slip garment and methods of fabricating such a garment.

In particular, the present invention relates to hosiery, such as tights, stockings, socks and pantihose, having predetermined slip-resistant portions to prevent the wearer's foot from slipping in the garment and/or preventing the garment from slipping within the wearer's shoe.

### BACKGROUND OF THE INVENTION

In the construction of a typical nylon type stocking, there is a single material from the leg of the user down to the toe. Modern dress codes, as implicit as they are, require women to wear nylon type hosiery whenever they wear a dress or skirt. The soles of the hosiery, although often doubled or tripled in thickness, are still normally uncomfortable. The nylon tends to slip and slide within the shoe and does not have much absorbency for perspiration.

Nylon or the like stockings are also worn by both men and women for medical reasons such as varicose veins, gout or poor circulation. These stockings are typically worn underneath pants, and the user puts conventional socks over the stockings before putting on shoes.

Many manufacturers have tried to improve on this discomfort and support problem in the field of socks. Some have added leather or suede soles over the existing cloth, whereas others have put inserts of polyurethane, polyester or plastic foam inside the stocking.

Many of these inventions have improved the user's predicament, but have not relieved the problem of slippage in the shoe, or have added a problem of creating an uncomfortable bulk within the shoe of the wearer.

U.S. Pat. No. 832,550 issued to Lepper discloses a sock with a combined insole and retaining device. The retaining device is inserted into a standard hose or sock and allows the user to use a medicated pad to prevent or heal callouses, corns and the like. The device can also be worn on the outside of the hose, but in either case, is separated from the hose.

U.S. Pat No. 4,852,272 issued to Chilewich adhered a suede soul to a slipper sock by sewing the suede over a conventional sock. This is an improvement over Lepper, but because of the bulk, is not easily wearable inside a shoe.

While many of these earlier patents were directed to structures which improve the comfort and wearability of a sock or slipper sock, none of these patents teach a fully satisfactory structure for being able to wear the sock in a dress shoe, or being able to use the insert with nylon-type hosiery, or being able to solve the slippage problem.

Other sock or hosiery patents, such as U.S. Pat. No. 1,293,399 issued to Fry; U.S. Pat. No. 2,319,577 issued to Baird, and U.S. Pat. No. 1,106,208 issued to Hale, teach other sock and hosiery constructions which incorporate one or more features of a stocking having a comfort area. None, however, teach the construction of the present invention which solves the slippage problem.

Foreign Patents such as No.240,178 and 955,0498 from the United Kingdom and Patent Nos. 1.288.805 and 1.361.146 from France all discuss improved socks or slippers. None address the slippage problem.

Numerous innovations for stockings have been provided in the prior art that are described as follows. Even though these innovations may be suitable for the specific individual purposes which they address, they differ from the present invention as hereinafter contrasted.

U.S. Pat. No 4,277,959 issued to Thorneburg discloses athletic socks particularly suitable for jogging and running and having shock absorber cushion pads in the heel, ball, and in the inner portion of the arch area. The socks are formed by a sufficiently greater amount of yarn being knit in these portions than the amount of yarn knit in the outer portion of the arch. The shock absorber cushion pads protect and cushion the heel, ball and inner portion of the arch of the wearer's foot and reduce the shock normally imparted to the heel, ball and inner portion of the arch of the wearer's foot so that normal articulation of the bones in the feet takes place when the wearer is jogging and running. However, this invention fails to disclose a fine hosiery stocking providing non-slippage.

U.S. Pat. No. 5,133,088 issued to Dunlap discloses a formable or “puff” ink to form a friction producing surface on the back of the sock above the heel. However, this invention fails to disclose a nylon product which decreases the slippage in the shoe.

U.S. Pat. No. 4,373,361 issued to Thornburg discloses a ski sock which includes additional yarn nit in plated relationship with the body yarns to form a thickened fabric area extending down the front portion of the leg of the sock to cushion and protect the front portion of the leg of the wearer from discomfort caused by the front and upper edge of the ski boot. The ski sock also includes a thickened fabric area extending along the rear half of the sock and at least through the heel and sole area to cushion and protect the heel and lower portion of the foot of the wearer. However, this reference fails to disclose any type of fine hosiery providing non-slippage.

U.S. Pat. No 4,216,662 issued to Harris, Jr. et al. discloses a circular knit sock having a leg and upper foot portion knitted from a body yearn in a conventional stitch pattern, and a lower foot portion knitted from a combination of the body yarn and an auxiliary or reinforcement yarn of a second fiber content in cushion stitch which has: (1) a first set of alternating courses knitted from the body yarn; (2) a second set of alternating courses knitted from a combination of the body and reinforcement yarns; (3) a first set of alternating wales formed of plain stick loops made from a combination of the body yarn and the auxiliary yarn; and (4) a second set of alternating wales formed of successive tuck stitches made from the combined auxiliary and body yarns of one course and the body yarn of the proceeding or adjacent course. However, this reference fails to disclose any type of fine hosiery such as nylons which solves the slippage problem.

U.S. Pat. No. 4,615,188 issued to Hursh et al. discloses a knit sock, especially for jogging or other athletic activity, having a foot portion consisting of a first inner layer or ply disposed inside a second outer layer or ply. The first ply of the foot portion has an inner surface adapted to contact the skin formed principally of yarns having high frictional characteristics, high thermal conductivity, and low moisture regain (hydrophobic). Its opposed surface is formed principally of yarns having relatively low frictional characteristics. The second ply has an inner surface which has low frictional characteristics and its outer surface is formed of yarns having relatively high frictional characteristics and high moisture regain (hydrophilic). The latter surface may also be formed with terry loops to enhance its shock absorbing construction as well as to increase its moisture absorbing capacity. However, this reference also fails to disclose any type of fine hosiery, such as nylons, which solve the slippage problem.

U.S. Pat. No. 5,787,509 issued in 1998 to Alvera entitled “STOCKING HAVING A COMFORT FOOT AREA” discloses a fine hosiery stocking wherein a pad is sized to cover and be secured to the comfort area or integrally knit or woven into the comfort area to act as a liner to protect and comfort the foot of the wearer of the stocking.

None of the conventional devices and techniques contemplates a garment having predetermined areas which eliminates slippage between the garment and the wearer's body and/or between the garment and the wearer's footwear.

Indeed, a desideratum of the present invention is to avoid the animadversions of the conventional devices and techniques. It would thus be desirable to provide a garment, such as a nulon garment, which eliminates or avoids the slippage problems mentioned hereinabove.

### SUMMARY OF THE INVENTION

The present invention provides a new and useful method of fabricating a non-slip garment, comprising the steps of: mixing together predetermined amounts of a plastisol, a nylon bonding, and a mineral oil to form a plastisol mixture; applying said plastisol mixture over predetermined portions of a garment; heating said garment with said plastisol mixture for a predetermined period of time and at a predetermined temperature; cooling said heated garment with said plastisol mixture for a predetermined time and at a predetermined temperature; then subjecting said cooled garment with said plastisol mixture to room temperature for a predetermined period of time.

The present invention also provides a new and useful garment comprising a main body portion of said garment; and one or more slip-resistant portions affixed to said main portion of said garment.

The present invention also provides a new and useful garment having predetermined slip-resistant portions which prevent slippage between the garment and the wearer and/or between the garment and footwear of the wearer.

It is, therefore, one of the primary objects of the present invention to provide a garment, such as hosiery, having one or more slip-resistant portions, located at the bottom of the foot portion of the hosiery, thereby preventing the wearer's foot from sliding in the hosiery.

A further object of the present invention is to provide a garment and a novel method of fabricating same, wherein the wearer's foot is kept stationary and relatively centered in the wearer's shoe.

Another object of the present invention is to provide a garment having slip-resistant portions which may be located either on the outside of the garment, or on the inside of the garment, or both.

Another option of the present invention is to provide a garment and method as described hereinabove wherein the slip-resistant portion or portions are hypoallergenic, thereby avoiding irritation of the wearer.

The present invention possesses many advantages and features which will become more apparent to those persons skilled in this particular area of technology and to others after having been exposed to the detailed descriptions of some exemplary preferred embodiments of the present invention as set forth hereinbelow in conjunction with the accompanying drawings.

### BRIEF DESCRIPTION OF THE DRAWINGS

FIG. 1 illustrates a first embodiment of the present invention in which the slip-resistant portion of the invention has an oval shape.

FIG. 2 illustrates another embodiment of the present invention in which the slip-resistant hosiery portion has an oblong shape.

FIGS. 3A and 3B illustrate another embodiment of the present invention in which the slip-resistant resistant portion of the invention has a floral design pattern.

### DETAILED DESCRIPTION OF SOME PREFERRED EMBODIMENTS

First there will be described an exemplary method of fabricating a non-slip garment in accordance with the present invention.

A form or mock-up (not shown) of a wearer's foot is wrapped with Teflon or parchment paper.

Thereafter, a nylon stocking is slid over the top of the wrapped mock-ups. If necessary, metal clamps or fastening devices are employed to keep the stocking on the mock-up in place.

A plastisol mixture, comprising a throughly and evenly mixed portion of plastisol, nylon bonding, and a mineral oil is prepared. Preferably, but not necessarily, one teaspoon of plastisol is mixed with one-half teaspoon of nylon bonding, and one eye drop of mineral oil.

The resulting plastisol mixture is evenly applied or spread over a design on predetermined portions of the nylon garment.

Thereafter, preferably not necessarily, the assemblage is heated or baked at approximately 350 degrees Fahrenheit for approximately 10 minutes.

After the heating step, the garment may be taken out and cooled in a refrigerator or some other suitable cooling device for five minutes.

Thereafter, the garment is removed from the refrigerator and subjected to room temperature for 10 to 15 minutes. Thereafter, the foot mock-up may be removed from the garment. There results in the design a rubberized non-slip portion, which may be as thin or thick as desired.

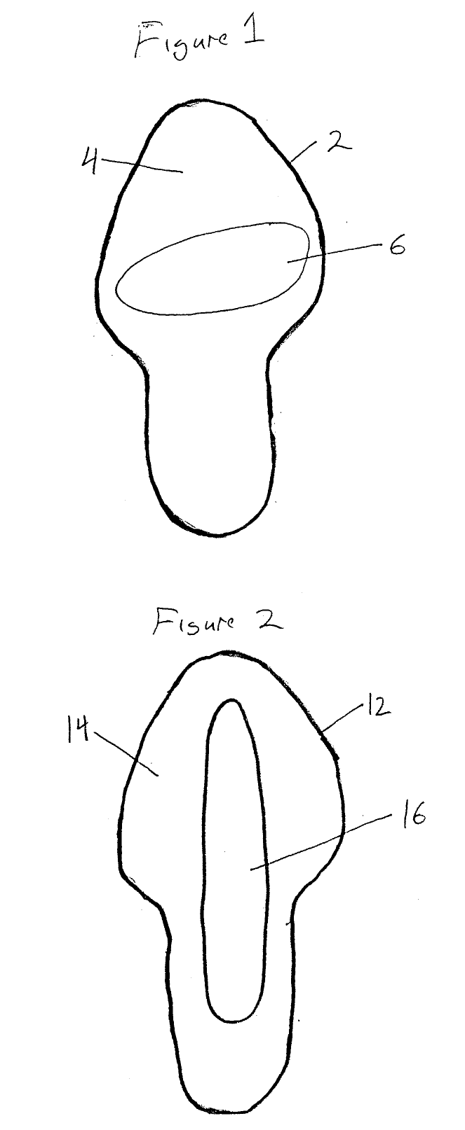

Now referring to FIG. 1, a sock 2 has an exterior sole portion 4. The exterior sole portion 4 has in turn a slip-resistant portion 6 located in such manner as to be below the “ball” of the wearer's foot (not shown).

In FIG. 1, the slip-resistant portion 6 is oval-shaped; however, in other embodiments of the invention the slip-resistant portion may be circular, etc., or even a decorative pattern, as long as the slip-resistant portion has slip-resistant characteristics. For example, in FIG. 2, a sock 12 has an exterior sole portion 14 which in turn has a slip-resistant portion 16 which is oblong in shape.

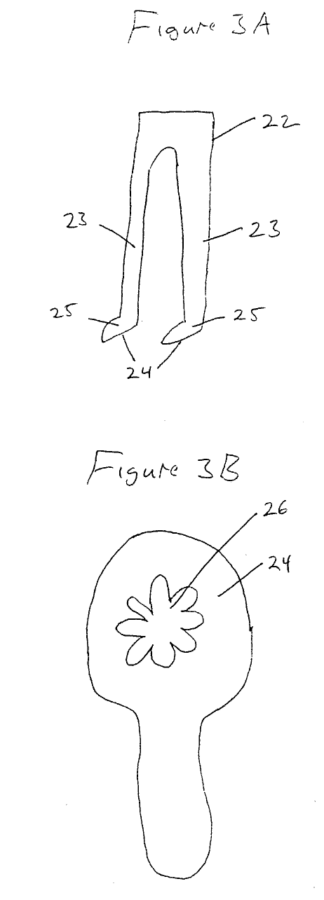

In FIG. 3A, tights 22 have leg portions 23 and exterior sole portions 24 located on foot portions 25 of the tights 22. As shown in FIG. 3B, the sole portions 24 each have a slip-resistant portion 26 which is an aesthetically pleasing floral design made of a slip-resistant material.

The slip-resistant portions may be located on the exterior or interior portions, or both, of the foot portions of hosiery, tights, socks, stockings, etc. and preferably are manufactured from a hypoallergenic material.

While the embodiments described hereinabove relate to stockings and tights, the present invention also relates to other types of garments where it is desired to provide slip-resistant portions.

There have been illustrated in the accompanying drawings and described hereinabove only some unique and novel preferred embodiment of the present invention, which can be constructed in several configurations, sizes and shapes.

It should be understood that many changes, modifications, variations, and other uses and applications will become apparent to those persons skilled in this particular area of technology and to other persons after having been exposed to the present patent application and accompanying drawings.

Any and all such changes, modifications, variations, and other uses and applications which do not depart from the spirit and scope of the present invention are therefore covered by and embraced within the present invention and the patent claims set forth hereinbelow.

1. A method of fabricating a non-slip garment comprising the steps of:
mixing together predetermined amounts of a plastisol, a nylon bonding, and a mineral oil to form a plastisol mixture;
applying said plastisol mixture over predetermined portions of a garment;
heating said garment with said plastisol mixture for a first predetermined period of time and at a first predetermined temperature;
cooling said heated garment with said plastisol mixture for a second predetermined period of time at a second predetermined temperature; and
subjecting said cooled garment with said plastisol mixture to room temperature for a third predetermined period of time.

2. The method of fabricating a non-slip garment according to claim 1, wherein:
said plastisol mixture is applied over said predetermined portions of said garment by spreading said plastisol mixture over said predetermined portions of said garment.

3. The method of fabricating a non-slip garment according to claim 1, wherein:
said plastisol mixture is applied over said predetermined portions of said garment to produce slip-resistant portions which are located on the exterior of said garment.

4. The method according to claim 2, wherein:
said plastisol mixture is applied over said predetermined portions of said garment to produce slip-resistant portions which are located on the exterior of said garment.

5. The method of fabricating a non-slip garment according to claim 1, wherein:
said plastisol mixture is applied over said predetermined portions of said garment to produce slip-resistant portions which are located on the interior of said garment.

6. The method according to claim 2, wherein:
said plastisol mixture is applied over said predetermined portions of said garment to produce slip-resistant portions which are located on the interior of said garment.

7. The method according to claim 1, wherein:
said plastisol mixture is applied over said predetermined portions of said garment to produce one or more slip-resistant portions which are shaped to conform with the contours of the metatarsal and heel of the wearer's foot.

8. The method according to claim 2, wherein:
said plastisol mixture is applied over said predetermined portions of said garment to produce one or more slip-resistant portions which are shaped to conform with the contours of the metatarsal and heel of the wearer's foot.

9. The method according to claim 3, wherein:
said plastisol mixture is applied over said predetermined portions of said garment to produce one or more slip-resistant portions which are shaped to conform with the contours of the metatarsal and heel of the wearer's foot.

10. The method according to claim 4, wherein:
said plastisol mixture is applied over said predetermined portions of said garment to produce one or more slip-resistant portions which are shaped to conform with the contours of the metatarsal and heel of the wearer's foot.

11. The method according to claim 5, wherein:
said plastisol mixture is applied over said predetermined portions of said garment to produce one or more slip-resistant portions which are shaped to conform with the contours of the metatarsal and heel of the wearer's foot.

12. The method according to claim 6, wherein:
said plastisol mixture is applied over said predetermined portions of said garment to produce one or more slip-resistant portions which are shaped to conform with the contours of the metatarsal and heel of the wearer's foot.

13. A garment comprising:
a main body portion of said garment;
one or more slip-resistant portions affixed to said main portion of said garment.

14. A garment according to claim 13, wherein:
each of said slip-resistant portions are hypo-allergenic.

15. A garment according to claim 13, wherein:
one or more of said slip-resistant portions is provided on an exterior surface of said main body portion of said garment.

16. A garment according to claim 14, wherein:
one or more of said slip-resistant portions is provided on an exterior surface of said main body portion of said garment.

17. A garment according to claim 13, wherein:
one or more of said slip-resistant portions is provided on an interior surface of said main body portion of said garment.

18. A garment according to claim 14, wherein:
one or more of said slip-resistant portions is provided on an interior surface of said main body portion of said garment.

19. A garment according to claim 15, wherein:
one or more of said slip-resistant portions is provided on an interior surface of said main body portion of said garment.

20. A garment according to claim 16, wherein:
one or more of said slip-resistant portions is provided on an interior surface of said main body portion of said garment.
